(19) United States
(12) Patent Application Publication
(10) Pub. No.: US 2023/0316301 A1
(43) Pub. Date: Oct. 5, 2023

(54) SYSTEM AND METHOD FOR PROACTIVE CUSTOMER SUPPORT

(71) Applicant: Dell Products L.P., Round Rock, TX (US)

(72) Inventors: Helena Shi, Plano, TX (US); Jui Gupta, Austin, TX (US); Sai Abhishek Pidaparthi, Austin, TX (US); Akhil Bhat, Frederick, MD (US); Jay Prakash Kumar, Purnea (IN); Avtansh Sharma, Agra (IN); Aashay Nandkumar Bane, Mumbai (IN)

(73) Assignee: Dell Products L.P., Round Rock, TX (US)

(21) Appl. No.: 17/654,455

(22) Filed: Mar. 11, 2022

(51) Int. Cl. G06Q 30/02; G06N 20/20

(52) U.S. Cl. CPC G06Q 30/0202; G06N 20/20; G06Q 30/0613

(57) ABSTRACT

In one aspect, an example methodology implementing the disclosed techniques includes, by a computing device, receiving clickstream information of a customer visiting a website of an organization, the clickstream information is indicative of an active web session of the customer on the website, and predicting, using a machine learning (ML) model, a propensity of the customer performing a particular action during the active web session on the website. The method also includes, by the computing device, providing proactive customer support to the customer based on the predicted propensity of the customer performing the particular action. The website may be a support website of the organization. The particular action may include contacting technical support of the organization and/or making a purchase during the active web session of the customer on the website.

### BACKGROUND

Organizations that sell products, such as electronic products, may provide support websites where their customers can seek information, troubleshoot issues with their products, and solve problems encountered using their products. For instance, when a customer who encounters a problem (e.g., hardware issue, software issue, etc.) with a computing device, the customer may visit and browse web pages and applications on a support website provided by an organization that sold the computing device in an effort to find a solution to the problem. Unfortunately, in many instances, the customer may not be able to resolve their problem by browsing the support website and, in turn, contact the organization’s technical support department via phone, email, chat, or other traditional means.

However, the costs associated with the traditional contact (e.g., phone, email, live chat, etc.) to the technical support department is high. For instance, the organization needs to employ large numbers of technical support specialists to answer/reply/handle each phone call, email, live chat, etc., to the technical support department. To reduce the costs associated with the traditional contact to their technical support departments, organizations are increasingly implementing automated software agents (or “chatbots”) and presenting the software agents to every customer visiting their support websites.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

In accordance with one illustrative embodiment provided to illustrate the broader concepts, systems, and techniques described herein, a method includes, by a computing device, receiving clickstream information of a customer visiting a website of an organization, the clickstream information is indicative of an active web session of the customer on the website, and predicting, using a machine learning (ML) model, a propensity of the customer performing a particular action during the active web session on the website. The method also includes, by the computing device, providing proactive customer support to the customer based on the predicted propensity of the customer performing the particular action.

According to another illustrative embodiment provided to illustrate the broader concepts described herein, a system includes one or more non-transitory machine-readable mediums configured to store instructions and one or more processors configured to execute the instructions stored on the one or more non-transitory machine-readable mediums. Execution of the instructions causes the one or more processors to carry out a process including receiving clickstream information of a customer visiting a website of an organization, the clickstream information is indicative of an active web session of the customer on the website, and predicting, using a machine learning (ML) model, a propensity of the customer performing a particular action during the active web session on the website. The process also includes providing proactive customer support to the customer based on the predicted propensity of the customer performing the particular action.

In some embodiments, the ML model is a ML classification model.

In one aspect, the ML classification model is a gradient boosting classifier.

In another aspect, the ML classification model is a random forest classifier.

In another aspect, the ML classification model is a decision tree classifier.

In another aspect, the ML classification model is a logistic regression model.

In some embodiments, the ML model is trained using a modeling dataset generated from a corpus of historical web journey data of customer web sessions on the website.

In some embodiments, the website is a support website of the organization.

In some embodiments, the particular action includes contacting technical support of the organization.

In some embodiments, the particular action includes making a purchase.

In some embodiments, providing proactive customer support includes prompting a virtual assistant (VA) of the website to engage the customer to proactively facilitate performance of the particular action.

According to another illustrative embodiment provided to illustrate the broader concepts described herein, a method includes, by a computing device, receiving clickstream information of a customer visiting a support website of an organization, the clickstream information is indicative of an active web session of the customer on the support website, and predicting, using a machine learning (ML) classification model, a propensity of the customer performing a particular action during the active web session on the website. The method also includes, by the computing device, responsive to a prediction of the customer having a propensity to perform the particular action, prompting a virtual assistant (VA) of the support website to engage the customer to proactively facilitate performance of the particular action.

According to another illustrative embodiment provided to illustrate the broader concepts described herein, a system includes one or more non-transitory machine-readable mediums configured to store instructions and one or more processors configured to execute the instructions stored on the one or more non-transitory machine-readable mediums. Execution of the instructions causes the one or more processors to carry out a process including receiving clickstream information of a customer visiting a support website of an organization, the clickstream information is indicative of an active web session of the customer on the support website, and predicting, using a machine learning (ML) classification model, a propensity of the customer performing a particular action during the active web session on the website. The process also includes, responsive to a prediction of the customer having a propensity to perform the particular action, prompting a virtual assistant (VA) of the support website to engage the customer to proactively facilitate performance of the particular action.

In some embodiments, the ML classification model is one of a gradient boosting classifier, a random forest classier, a decision tree classifier, or a logistic regression model.

In some embodiments, the particular action includes contacting technical support of the organization.

In some embodiments, the particular action includes making a purchase.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1A is a block diagram of an illustrative network environment for proactive customer support on a support website, in accordance with an embodiment of the present disclosure.

FIG. 1B is a block diagram of an illustrative proactive customer support service, in accordance with an embodiment of the present disclosure.

FIG. 2 shows an illustrative workflow for a model building process, in accordance with an embodiment of the present disclosure.

FIG. 3A is a diagram illustrating a portion of a data structure that can be used to store information about relevant features of a modeling dataset for training a machine learning (ML) classification model to predict a propensity of a customer contacting customer support, in accordance with an embodiment of the present disclosure.

FIG. 3B is a diagram illustrating a portion of a data structure that can be used to store information about relevant features of a modeling dataset for training a machine learning (ML) classification model to predict a propensity of a customer making a purchase, in accordance with an embodiment of the present disclosure.

FIG. 4 is a flow diagram of an example process for providing proactive support to customers visiting a support website, in accordance with an embodiment of the present disclosure.

FIG. 5 is a block diagram illustrating selective components of an example computing device in which various aspects of the disclosure may be implemented, in accordance with an embodiment of the present disclosure.

### DETAILED DESCRIPTION

As noted above, an organization may implement and present a chatbot to every customer visiting the organization’s support website. However, presenting the chatbot to every customer visiting their support website can lead to reduced customer satisfaction. For example, customers visiting the website may be annoyed with the continued display of a chatbot-related popup window on their screens. This may be especially so for customers who may simply be searching for information on the support website with no intention of contacting and/or interacting with the organization via the website. Or, it may just be that a customer prefers to not interact with a chatbot (e.g., the customer prefers a human agent to a chatbot for their technical/customer service engagement). This can also lead to reduced engagement of customers with the support website (e.g., reduced purchases of products and services via the website).

Certain embodiments of the concepts, techniques, and structures disclosed herein are directed to an artificial intelligence (AI)/machine learning (ML)-powered framework for providing proactive support to customers of an organization visiting or otherwise interacting with the organization’s website such as a support website. The proactive support capability is provided by a website propensity index (WPI) module that utilizes AI/ML to predict a propensity of a customer action that is of interest to the organization during a customer’s active or current session (or “web session”) on the organization’s support website. In some such embodiments, the prediction may be based on the customer’s web journey data on the organization’s support website (e.g., actions performed during the customer’s active or current web session on the organization’s support website). In some embodiments, in response to identifying a customer having a propensity to perform an action that is of interest to the organization, the WPI module can prompt or otherwise cause a virtual assistant (VA) component or module of the support website to engage with the customer to assist the customer in performing the action. In one such embodiment, the VA component can engage the customer by initiating a virtual assistant chatbot configured to assist the customer perform the action or other action during the customer’s active or current web session on the organization’s support website.

The illustrative embodiments recognize that the degree to which any AI/ML system is useful, robust, and reliable depends on the quantity and quality of the modeling data used for training and validating the system to perform its functions. Within the context of prediction of some customer action during a web session, the system can be trained using a modeling dataset generated from historical web journey data of the organization’s customers on the organization’s support website.

In some embodiments, the framework provides a classification algorithm (e.g., a classification algorithm) that is trained using machine learning techniques to predict a propensity of a customer who is visiting an organization’s support website contacting the organization’s technical support via means of a phone call, an email, a chat exchange, or other traditional means of contact, during the customer’s active web session on the support website. For example, in one embodiment, a gradient boosting algorithm may be trained using a modeling dataset generated from historical web journey data of the organization’s customers on the organization’s support website (e.g., a corpus of one to two years of historical web journey data on the organization’s support website). The modeling data can be used to train the gradient boosting algorithm using supervised learning where the target variable is whether a customer visiting the support website shows a propensity to contact the organization’s technical support during the active web session on the support website (i.e., during the customer’s current visit to the support website). The ML classification model (e.g., the gradient boosting classifier) can then be used to predict a propensity of a customer visiting the organization’s support website contacting the organization’s technical support.

In some embodiments, the framework may also provide a classification algorithm (e.g., a classification algorithm) that is trained using machine learning techniques to predict a propensity of a customer who is visiting an organization’s support website making a purchase during the customer’s active web session on the support website. The purchase, for example, may be of a service for repair of a product (e.g., repair of the customer’s product) and/or parts and accessories for the product (e.g., parts/accessories for a do-it-yourself repair of the customer’s product). The purchase may be for services and/or parts/accessories unrelated to a repair of the product. For example, in one embodiment, a gradient boosting algorithm may be trained using a modeling dataset generated from historical web journey data of the organization’s customers on the organization’s support website (e.g., a corpus of one to two years of historical web journey data on the organization’s support website). The modeling data can be used to train the gradient boosting algorithm using supervised learning where the target variable is whether a customer visiting the support website shows a propensity to make a purchase during the active web session on the support website (i.e., during the customer’s current visit to the support website). The ML classification model (e.g., the gradient boosting classifier) can then be used to predict a propensity of a customer visiting the organization’s support website making a purchase.

It will be understood that the framework described in this disclosure can be generally expanded to include prediction of a propensity of any number of customer actions in addition to and/or other than propensity to contact or propensity to make a purchase. For example, the framework can provide a first ML model that can be used to predict a propensity of a customer visiting the organization’s support website making a purchase of a specific service or product/accessory. As another example, the framework can provide a second ML model that can be used to predict a propensity of a customer whose product is out-of-warranty visiting the organization’s support website making a purchase of an extended warranty for the product.

As used herein, the term “customer” refers, in addition to its ordinary meaning, to a visitor on an organization’s support website that inputs or otherwise provides to the support website a unique identifier (e.g., serial number or other product identifier) of a product sold by the organization or other identifying information that allows for identifying the visitor as a customer. For example, inputting a unique identifier of a product enables the organization to distinguish between visitors on the support website who are customers of the organization and anonymous visitors. In putting the unique identifier also enables the organization to identify the customer as well as other information about the product such as, for example, the type of product, current warranty status, and product age, to provide several examples. The organization may store or otherwise maintain such information in one or more enterprise systems (e.g., order management (OM) system, customer relationship management (CRM) system, information technology service management (ITSM) system, etc.) utilized by the organization. The visitor who input the unique identifier may or may not have purchased the product.

As used herein, the term “web journey data” (or “journey data”), refers, in addition to its ordinary meaning, to information and data about the actions taken or performed by a user such as may be collected during a web session on a website. The web journey data can be understood as also including information and data about the user performing the actions and the user’s product. For example, a customer’s web journey data can be understood as comprising information and data about the customer, the customer’s product, and the actions taken or performed by the customer during a web session on the organization’s support website (e.g., information about the customer’s interactions with the organization’s support website). Thus, for example, in a particular implementation, a customer’s web journey data can be determined or derived from the customer’s clickstream on the organization’s support website.

Although certain embodiments, examples, and/or definitions are described and/or provided herein in the context of an organization’s support website, it will be appreciated in light of this disclosure that such embodiments, examples, and/or definitions are not intended to be and should not be construed as limiting. Rather, the concepts described herein are applicable to websites other than support websites, such as, for example, an organization’s sales website, where providing proactive customer/visitor/user support may be of benefit to the organization. Numerous variations and configurations will be apparent in light of this disclosure.

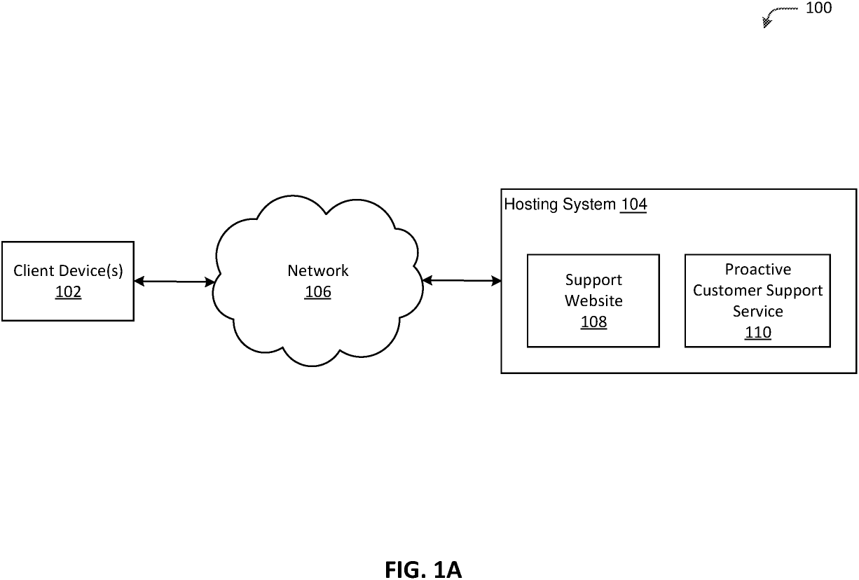

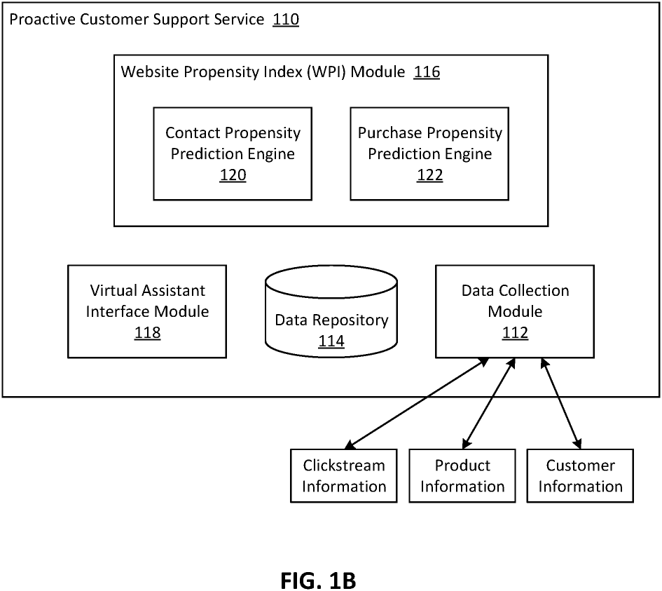

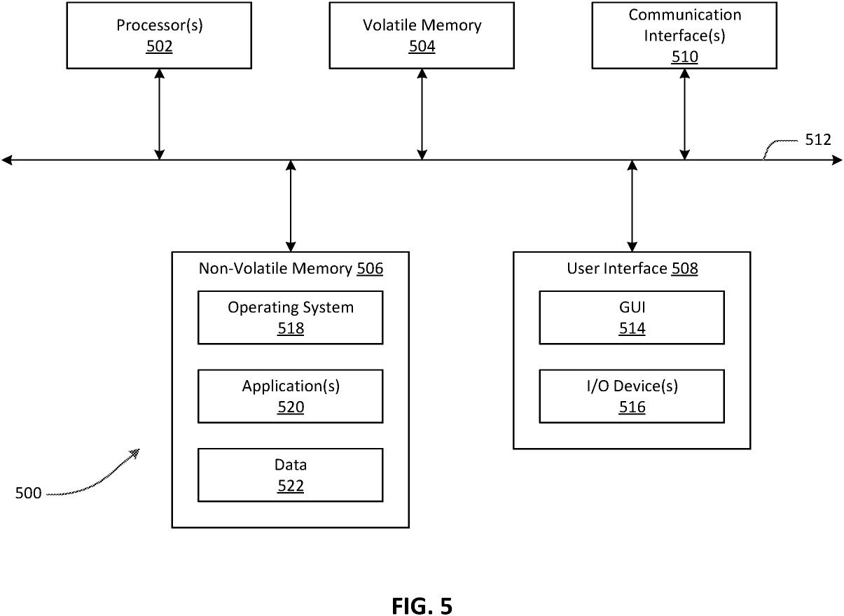

Turning now to the figures, FIG. 1A is a block diagram of an illustrative network environment 100 for proactive customer support on a support website, in accordance with an embodiment of the present disclosure, As illustrated, network environment 100 may include one or more client devices 102 communicatively coupled to a hosting system 104 via a network 106. Client devices 102 can include smartphones, tablet computers, laptop computers, desktop computers, workstations, or other computing devices configured to run user applications (or “apps”). In some implementations, client device 102 may be substantially similar to a computing device 500, which is further described below with respect to FIG. 5.

Hosting system 104 can include one or more computing devices that are configured to host and/or manage applications and/or services. Hosting system 104 may include load balancers, frontend servers, backend servers, authentication servers, and/or any other suitable type of computing device. For instance, hosting system 104 may include one or more computing devices that are substantially similar to computing device 500, which is further described below with respect to FIG. 5.

In some embodiments, hosting system 104 can be provided within a cloud computing environment, which may also be referred to as a cloud environment, cloud computing or cloud network. The cloud computing environment can provide the delivery of shared computing services (e.g., microservices) and/or resources to multiple users or tenants. For example, the shared resources and services can include, but are not limited to, networks, network bandwidth, servers, processing, memory, storage, applications, virtual machines, databases, software, hardware, analytics, and intelligence.

As shown in FIG. 1A, hosting system 104 may include a support website 108 and a proactive customer support service 110. Support website 108 is generally configured to provide services of product support for an organization that manufactures and/or sells products, such as electronic devices. For example, when a customer of the organization encounters a problem with his/her product, the customer may browse different applications and web pages (or “pages”) of support website 108 to find a solution for the problem being encountered by the product. Examples of applications and pages on support website 108 may include computer programs for the organization’s products, articles and content related to the organization’s products, contact the organization’s order support, online diagnostic engine(s), order status, warranty, service store, and support incidents. As described in further detail at least with respect to FIGS. 1B-4, proactive customer support service 110 is generally configured to provide a framework for proactive customer support on a support website such as, for example, support website 108.

Network 106 may correspond to one or more wireless or wired computer networks including, but not limited to, local-area networks (LANs), metropolitan area networks (MANs), wide area networks (WANs), wireless local-area networks (WLAN), primary public networks, primary private networks, cellular networks, Wi-Fi (i.e., 802.11) networks, Bluetooth networks, the Internet, and/or any other suitable type of communications network. In some embodiments, network 106 may include another network or a portion or portions of other networks.

FIG. 1B is a block diagram of proactive customer support service 110, in accordance with an embodiment of the present disclosure. An organization such as a company, an enterprise, or other entity that manufactures and/or sells products (e.g., electronic devices), for instance, may implement and use the framework of proactive customer support service 110 to provide proactive support to customers visiting its support website, such as support website 108. Proactive customer support service 110 can be implemented as computer instructions executable to perform the corresponding functions disclosed herein. Proactive customer support service 110 can be logically and/or physically organized into one or more components. The various components of proactive customer support service 110 can communicate or otherwise interact utilizing application program interfaces (APIs), such as, for example, a Representational State Transfer (RESTful) API, a Hypertext Transfer Protocol (HTTP) API, or another suitable API, including combinations thereof.

In the example of FIG. 1B, proactive customer support service 110 includes a data collection module 112, a data repository 114, a website propensity index (WPI) module 116, and a virtual assistant interface module 118. Proactive customer support service 110 can include various other components (e.g., software and/or hardware components) which, for the sake of clarity, are not shown in FIG. 1B. It is also appreciated that proactive customer support service 110 may not include certain of the components depicted in FIG. 1B. For example, in certain embodiments, proactive customer support service 110 may not include one or more of the components illustrated in FIG. 1B, but proactive customer support service 110 may connect or otherwise couple to the one or more components via a communication interface. Thus, it should be appreciated that numerous configurations of proactive customer support service 110 can be implemented and the present disclosure is not intended to be limited to any particular one. That is, the degree of integration and distribution of the functional component(s) provided herein can vary greatly from one embodiment to the next, as will be appreciated in light of this disclosure.

Referring to proactive customer support service 110, data collection module 112 is operable to receive or collect information about clickstreams of customers visiting support website 108. For instance, data collection module 112 may receive such clickstream information from one or more web servers that are hosting support website 108 (e.g., hosting system 104). The clickstream information can include information about how the visitor is navigating through support website 108 during the customer’s active or current web session. For example, for a particular customer who is visiting support website 108, the clickstream information may include pages visited, time spent on each page, number of clicks on each page, how the customer arrived on the page, applications accessed, time spent on each application, number of clicks on each application, how the customer arrived at the application, inputs made or provided by the customer to support website 108, content/computer programs downloaded by the customer, etc., during the customer’s active or current web session. Thus, the clickstream information is indicative of the active or current web session of the customer on support website 108. Note that this list of clickstream information is merely illustrative and may vary depending on the capabilities of hosting system 104 that is hosting support website 108.

In some embodiments, data collection module 112 can receive/collect clickstream information from hosting system 104 on a continuous or periodic basis such as, for example, every 45 seconds, 60 seconds, 75 seconds, or any other suitable period. The period with which data collection module 112 receives/collects the clickstream information may be configurable by the organization. The clickstream information of a customer may be received on a continuous or periodic basis during the duration of the customer’s active or current web session on support website 108.

Data collection module 112 can use the clickstream information of a customer visiting support website 108 to retrieve information about the customer and the customer’s product. As explained above, a user visiting support website 108 may input a unique identifier that identifies the user’s product. Input of such product identifier allows proactive customer support service 110, and more generally support website 108 to identify the user visiting support website 108 as a customer of the organization based on the indicated product (i.e., based on the product identified by the input unique identifier). To determine the input unique identifier, data collection module 112 can scan parse, or otherwise analyze the received/collected clickstream information of the customer. Data collection module 112 can then use the unique identifier to retrieve information about the customer (e.g., name, status, customer location, etc.) and information about the product (e.g., type of product, product age, product configuration, current warranty status, etc.) from one or more data sources. The data sources can include the organization’s enterprise systems and data repositories. The enterprise systems can include, for example, OM systems, CRM systems, and/or ITSM systems. The data repositories can include, for example, DROPBOX, MICROSOFT ONEDRIVE, SHAREFILE, cloud-based storage service, or other suitable file system that hosts files, documents, and other materials. In some cases, the data sources can include third party and/or vendor websites.

In some embodiments, data collection module 112 can retrieve the information about a customer and the customer’s product each time clickstream information is received or collected (e.g., each time clickstream information of the customer is received or collected). The clickstream information of a customer and the information about the customer and the customer’s product is collectively referred to herein as the “a customer’s web journey data.” A customer’s web journey data describes the customer’s journey during the customer’s active or current web session on support website 108. In other embodiments, data collection module 112 can retrieve the information about a customer and the customer’s product according to a preconfigured schedule such as, for example, once every 24 hours. The frequency with which data collection module 112 retrieves the information about a customer and the customer’s product may be configurable by the organization. In some embodiments, data collection module 112 can store the web journey data of customers visiting support website 108 within data repository 114. In some embodiments, data repository 114 may correspond to a storage service within the computing environment of proactive customer support service 110.

In response to the clickstream information of a customer being received or collected, data collection module 112 can send a request to WPI module 116 to provide proactive customer support to the customer (i.e., the customer associated with the received/collected clickstream information). The request to provide proactive customer support to the customer can include the customer’s web journey data.

Data collection module 112 may utilize APIs provided by hosting system 104 and the various data sources to collect information and materials therefrom. For example, data collection module 112 may use a REST-based API or other suitable web server API (e.g., HTTP API) provided by hosting system 104 to collect clickstream information therefrom. Data collection module 112 may also use a REST-based API or other suitable API provided by an enterprise application (e.g., the organization’s OM system, CRM system, ITSM system, etc.) to retrieve information therefrom (e.g., to retrieve information regarding the customer and the customer’s product). In the case of web-based applications, data collection module 112 may use a Web API provided by a web application to collect information therefrom. As another example, data collection module 112 may use a file system interface to retrieve the files containing customer information, product information, etc., from a file system. As yet another example, data collection module 112 may use an API to collect documents containing customer information, product information, etc., from a cloud-based storage service. A particular data source (e.g., an enterprise application and/or data source) may be hosted within a cloud computing environment (e.g., the cloud computing environment of proactive customer support service 110 or a different cloud computing environment) or within an on-premises data center (e.g., an on-premises data center of an organization that utilizes proactive customer support service 110).

Still referring to proactive customer support service 110, WPI module 116 is configured to provide proactive customer support to customers visiting support website 108. For example, in response to a request to provide proactive customer support to a customer being received, WPI module 116 can predict a propensity of the customer performing an action that is of interest to the organization on support website 108 during the customer’s active or current web session on support website 108. In response to determining that the customer has a propensity to perform the action of interest based on the prediction, WPI module 116 can prompt or otherwise cause a VA to engage with the customer to assist the customer in performing the action (e.g., cause the VA to engage with the customer to help the customer perform the action that is of interest to the organization). For example, in one embodiment, the VA can engage the customer by initiating a virtual assistant chatbot configured to assist the customer perform the action or other action during the customer’s active or current web session on support website 108.

The illustrative WPI module 116 in FIG. 1B includes a contact propensity prediction engine 120 and a purchase propensity prediction engine 122. WPI module 116 can utilize contact propensity prediction engine 120 to predict a propensity of a customer who is visiting support website 108 contacting the organization’s technical support via means of a phone call, an email, a chat exchange, or other traditional means of contact, during the customer’s active web session on support website 108. For example, in response to receiving a request to provide proactive customer support to a customer, WPI module 116 can use contact propensity prediction engine 120 to predict a propensity of the customer contacting the organization’s technical support via traditional means of contact. In response to a prediction that the customer has the propensity to contact technical support via traditional means of contact, WPI module 116 can prompt or otherwise cause a VA to engage the customer to proactively assist the customer resolve their issue(s) with their product without contacting technical support, for example.

Similarly, WPI module 116 can utilize purchase propensity prediction engine 122 to predict a propensity of a customer who is visiting support website 108 making a purchase during the customer’s active web session on support website 108 (e.g., making a purchase of a service for repair of the customer’s product, parts and accessories for the customer’s product, etc.). For example, in response to receiving a request to provide proactive customer support to a customer, WPI module 116 can use purchase propensity prediction engine 122 to predict a propensity of the customer making a purchase. In response to a prediction that the customer has the propensity to make a purchase, WPI module 116 can prompt or otherwise cause a VA to engage the customer to proactively facilitate the purchase. Causing a VA to proactively engage with a customer makes the technical support process and/or the service/product purchase process provided on support website 108 more efficient. In addition, the proactive engagement by the VA enhances the customer’s user experience on support website 108.

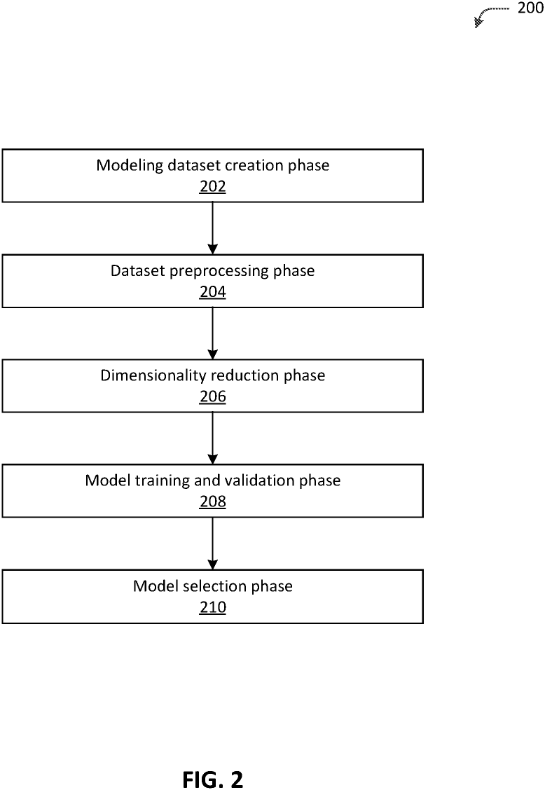

As mentioned previously, contact propensity prediction engine 120 is operable to predict a propensity of a customer who is visiting support website 108 contacting the organization’s technical support via traditional means of contact during the customer’s active web session on support website 108. To this end, in some embodiments, contact propensity prediction engine 120 can include a classification algorithm (e.g., a gradient boosting algorithm) that is trained and tested using machine learning techniques with a modeling dataset generated from historical web journey data of the organization’s customers on support website 108. In one embodiment, the modeling dataset can comprise one to two years of historical web journey data of customer web sessions on support website 108. Once the classification learning algorithm is trained, the ML classification model can, in response to input of a customer’s web journey data on support website 108 (i.e., input of information regarding a customer’s active or current web session on support website 108), predict a propensity of the customer contacting the organization’s technical support via traditional means based on the learned behaviors (or “trends”) in the modeling dataset. For example, contact propensity prediction engine 120 can use the customer’s web journey data to generate a feature vector that represents attributes of the customer’s web journey on support website 108, such as some or all the variables that may influence the prediction of a propensity of the customer to contact the organization’s technical support via traditional means. The generated feature vector can then be input to the ML classification model which outputs a prediction of the customer’s propensity to contact the organization’s technical support via traditional means. Further description of the training of the classification algorithm implemented within contact propensity prediction engine 120 is provided below at least with respect to FIG. 2.

As also mentioned previously, purchase propensity prediction engine 122 is operable to predict a propensity of a customer who is visiting support website 108 making a purchase during the customer’s active web session on support website 108. To this end, similar to contact propensity prediction engine 120 described above, in some embodiments, purchase propensity prediction engine 122 can include a classification algorithm (e.g., a gradient boosting algorithm) that is trained and tested using machine learning techniques with a modeling dataset generated from historical web journey data of the organization’s customers on support website 108. In one embodiment, the modeling dataset can comprise one to two years of historical web journey data of customer web sessions on support website 108. Once the classification learning algorithm is trained, the ML classification model can, in response to input of a customer’s web journey data on support website 108 (i.e., input of information regarding a customer’s active or current web session on support website 108), predict a propensity of the customer making a purchase based on the learned behaviors or trends in the modeling dataset. For example, purchase propensity prediction engine 122 can use the customer’s web journey data to generate a feature vector that represents attributes of the customer’s web journey on support website 108, such as some or all the variables that may influence the prediction of a propensity of the customer to make a purchase during the customer’s active web session on support website 108. The generated feature vector can then be input to the ML classification model which outputs a prediction of the customer’s propensity to make a purchase during the customer’s active web session on support website 108. Further description of the training of the classification algorithm implemented within purchase propensity prediction engine 122 is provided below at least with respect to FIG. 2.

Still referring to proactive customer support service 110, virtual assistant interface module 118 is operable to provide an interface to a VA component (not shown) of support website 108. For example, in one embodiment, virtual assistant interface module 118 may provide an interface that can be used to interface with the VA component of support website 108. For instance, WPI module 116 may send a request (or “message”) via virtual assistant interface module 118 to the VA component of support website 108 to engage with a customer who is visiting support website 108 perform an action. Such requests to the VA component may include information about the customer and the specific action(s) that the VA component is to assist the customer with. In some embodiments, in response to the request being received, the VA component can engage the customer by initiating a virtual assistant chatbot configured to assist the customer perform the action(s) or other action(s) during the customer’s active or current web session on support website 108.

Referring now to FIG. 2 and with continued reference to FIGS. 1A and 1B, shown is an illustrative workflow 200 for a model building process, in accordance with an embodiment of the present disclosure. In particular, workflow 200 is an illustrative process for creating a ML classification model (e.g., a gradient boosting classifier) for contact propensity prediction engine 120. The illustrative process of workflow 200 may also be performed to create a ML classification model (e.g., a gradient boosting classifier) for purchase propensity prediction engine 122. As shown, workflow 200 includes a modeling dataset creation phase 202, a dataset preprocessing phase 204, a dimensionality reduction phase 206, a model training and validation phase 208, and a model building phase 210.

In more detail, modeling dataset creation phase 202 can include collecting a corpus of web journey data from which to generate a modeling dataset. The corpus of web journey data can include the historical web journey data of the organization’s customers on support website 108. In one embodiment, one to two years of historical web journey data of customer web sessions on support website 108 may be collected from which to create the modeling dataset.

Dataset preprocessing phase 204 can include preprocessing the collected corpus of web journey data to be in a form that is suitable for training a classification algorithm (e.g., a gradient boosting algorithm). For example, in one embodiment, natural language processing (NLP) algorithms and techniques may be utilized to preprocess the collected text data (e.g., the one to two years of historical web journey data of customer web sessions on support website 108). For example, the data preprocessing may include tokenization (e.g., splitting a phrase, sentence, paragraph, or an entire text document into smaller units, such as individual words or terms), noise removal (e.g., removing whitespaces, characters, digits, and items of text which can interfere with the extraction of features from the data), stopwords removal, stemming, and/or lemmatization.

The data preprocessing may also include placing the data into a tabular format. In the table, the structured columns represent the features (also called “variables”) and each row represents an observation or instance (e.g., a particular web session of a customer on support website 108). Thus, each column in the table shows a different feature of the instance. The data preprocessing may also include placing the data (information) in the table into a format that is suitable for training a model. For example, since machine learning deals with numerical values, textual categorical values (i.e., free text) in the columns can be converted (i.e., encoded) into numerical values. According to one embodiment, the textual categorical values may be encoded using label encoding. According to alternative embodiments, the textual categorical values may be encoded using one-hot encoding or other suitable encoding methods.

The preliminary operations may also include handling of imbalanced data in the modeling dataset. For example, using a modeling dataset that contains biased information can significantly decrease the accuracy of the generated ML model (e.g., ML classification model). For example, in one embodiment, different weights may be assigned to each class (or “category”) in the modeling dataset. For example, in the modeling dataset for the classification algorithm of contact propensity prediction engine 120, there are two classes, contact and no contact. In the modeling dataset for the classification algorithm of purchase propensity prediction engine 122, there are two classes, purchase and no purchase. In either case, the weight assignment may be done in a manner so that a higher weight is assigned to the minority class and a lower weight (i.e., a lower weight relative to the weight assigned to the minority class) is assigned to the majority class. Here, the idea of weight assignment is to penalize the misclassification by the minority class(es). According to one embodiment, weights may be assigned as follows:

$$W e i g h t \text{} \_ \text{} c l a s s = \frac{n \text{} \_ \text{} s a m p l e s}{n \text{} \_ \text{} c l a s s e s \times n \text{} \_ \text{} s a m p l e s \text{} \_ \text{} i}$$

where Weight_class is a weight for each class; n_samples is the total number of samples available in the modeling dataset; n_classes is the total number of classes in the target variable (e.g., in both the modeling dataset for the classification algorithm of contact propensity prediction engine 120 and the modeling dataset for the classification algorithm of purchase propensity prediction engine 122, n_classes = 2); and n_samples_i is the total number of data samples in the respective classes.

The preliminary operations may also include feature selection and/or data engineering to determine or identify the relevant or important features from the noisy data. The relevant/important features are the features that are more correlated with the thing being predicted by the trained model (e.g., a propensity to contact the organization’s technical support for contact propensity prediction engine 120 or a propensity to make a purchase for purchase propensity prediction engine 122). A variety of feature engineering techniques, such as exploratory data analysis (EDA) and/or bivariate data analysis with multivariate-variate plots and/or correlation heatmaps and diagrams, among others, may be used to determine the relevant features. For example, the relevant features may include attributes of historical customer web sessions on support website 108, attributes of customers associated with the historical customer web sessions, and attributes of products associated with the historical customer web sessions.

Each instance in the table may represent a training/testing sample (i.e., an instance of a training/testing sample) in the modeling dataset and each column may be a relevant feature of the training/testing sample. As previously described, each training sample may correspond to a particular web session of a customer on support website 108. In a training/testing sample, the relevant features are the independent variables and the thing being predicted (e.g., a propensity to contact the organization’s technical support for contact propensity prediction engine 120 or a propensity to make a purchase for purchase propensity prediction engine 122) is the dependent variable. In some embodiments, the individual training/testing samples may be used to generate a feature vector, which is a multi-dimensional vector of elements or components that represent the features in a training/testing sample. In such embodiments, the generated feature vectors may be used for training or testing the classification algorithm (i.e., the ML classification model) to make a prediction.

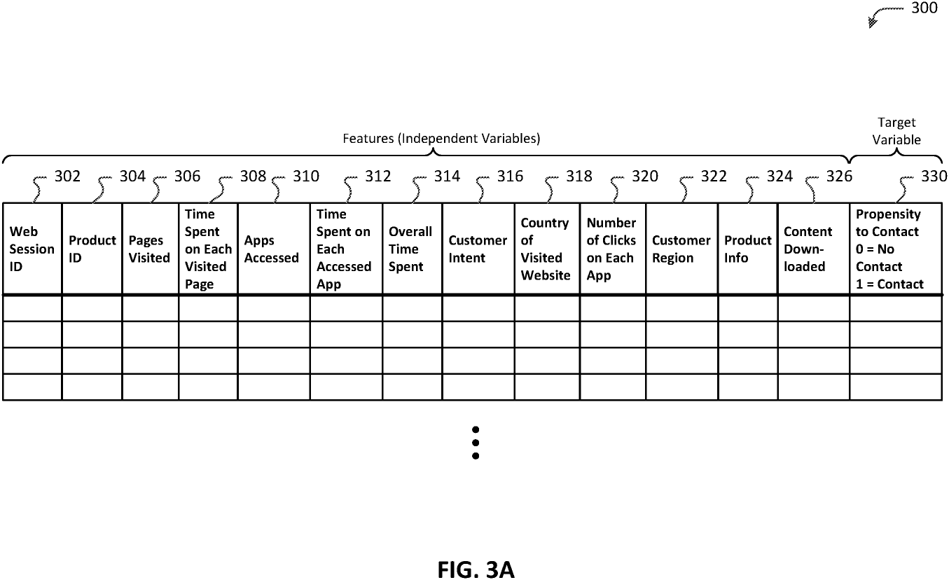

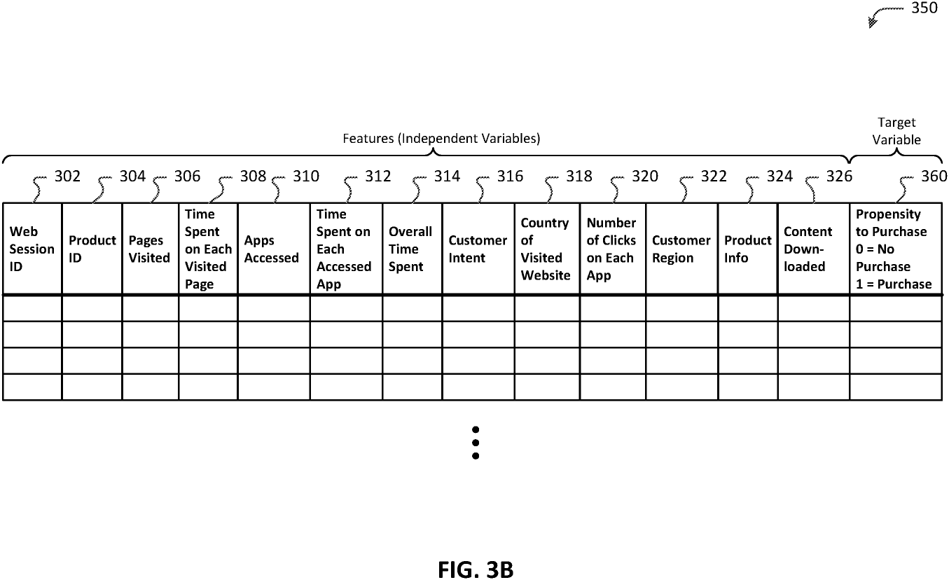

Dimensionality reduction phase 206 can include reducing the number of features in the dataset. For example, since the modeling dataset is being generated from the corpus of web journey data that includes one to two years of historical web journey data of customer web sessions on support website 108, the number of features (or input variables) in the dataset may be very large. The large number of input features can result in poor performance for machine learning algorithms. For example, in one embodiment, dimensionality reduction techniques, such as principal component analysis (PCA), may be utilized to reduce the dimension of the modeling dataset (e.g., reduce the number of features in the dataset), hence improving the model’s accuracy and performance. Examples of relevant features of respective modeling datasets for the ML classification model of contact propensity prediction engine 120 and the ML classification model of purchase propensity prediction engine 122 are provided below with respect to FIGS. 3A and 3B.

Model training and validation phase 208 can include training and validating the ML classification model (e.g., the gradient boosting classifier) using the modeling dataset. For example, various classification algorithms such as a gradient boosting algorithm, logistic regression, decision tree, random forest, and/or other suitable classification algorithm, may be trained and tested. In one embodiment, the modeling dataset can be separated into two (2) groups: one for training the ML classification model and the other for validating (or “evaluating”) the ML classification model. For example, based on the size of the modeling dataset, approximately 80% of the modeling dataset can be designated for training the ML classification model and the remaining portion (approximately 20%) of the modeling dataset can be designated for validating or evaluating the ML classification model. The model can then be trained by passing the portion of the modeling dataset designated for training (or “training dataset”) and specifying a number of epochs. An epoch (one pass of the entire training dataset) is completed once all the observations of the training data are passed through the model. The model can be validated using the portion of the modeling dataset designated for validating (or “testing dataset”) once the model completes a specified number of epochs. For example, the model can process the training dataset and a loss value (or “residuals”) can be computed and used to assess the performance of the model. The loss value indicates how well the model is trained. Note that a higher loss value means the model is not sufficiently trained. In this case, hyperparameter tuning may be performed to choose the optimal parameter for the selected classification algorithm. For example, hyperparameter tuning may be performed using a grid search algorithm or other suitable tuning algorithm/technique that attempts to compute the optimum values of hyperparameters. Hyperparameter tuning allows the model to tune the performance based on the characteristics of the data and multiple combinations of model parameters (e.g., max depth, maxBins, stepSize, and subsampling rate). Once the loss is reduced to a very small number (ideally close to 0), the model is sufficiently trained for prediction.

Model selection phase 210 can include selecting an appropriate ML classification model for predicting a propensity of a customer performing an action (e.g. a ML classification model of contact propensity prediction engine 120 and a ML classification model of purchase propensity prediction engine 122). For example, the selection may be based on the key classification metrics accuracy (Accuracy = (True Positive + True Negative) / (True Positive + False Positive +True Negative + False Negative)), recall (Recall = True Positive / (True Positive + False Negative)), and precision (Precision = True Positive / (True Positive + False Positive)). According to one embodiment, model selection phase 210 can include selecting a gradient boosting classifier as the ML classification model. Gradient boosting classification is an ensemble learning technique, where multiple weak learners are combined to make a final prediction. In the ensemble learning technique, the multiple weak learners are trained sequentially to reduce the classification error. According to other embodiments, model selection phase 210 can include selecting a logistic regression model, a decision tree classifier, or a random forest classifier as the ML classification model.

Referring now to FIG. 3A and with continued reference to FIGS. 1A and 1B, shown is a diagram illustrating a portion of a data structure 300 that can be used to store information about relevant features of a modeling dataset for training a machine learning (ML) classification model to predict a propensity of a customer contacting customer support, in accordance with an embodiment of the present disclosure. More specifically, data structure 300 may be in a tabular format in which the structured columns represent the different relevant features (variables) regarding the historical web journey data of the organization’s customers on support website 108 and a row represents individual historical web sessions of customers on support website 108. The relevant features illustrated in data structure 300 are merely examples of features that may be extracted from the historical web journey data of the organization’s customers on support website 108 and used to generate a modeling dataset and should not be construed to limit the embodiments described herein.

As shown in FIG. 3A, the relevant features may include a web session ID 302, a product ID 304, a pages visited 306, a time spent on each visited page 308, an apps accessed 310, a time spent on each accessed app 312, an overall time spent 314, a customer intent 316, a country of visited website 318, a number of clicks on each app 320, a customer region 322, a product info 324, a content downloaded 326, and a propensity to contact 330. Web session ID 302 identifies a historical customer web session on support website 108. Product ID 304 identifies a product sold by the organization (i.e., the product associated with the historical customer web session identified by web session ID 302). Pages visited 306 indicates the pages on support website 108 visited by the customer during the customer web session. Time spent on each visited page 308 indicates a duration (e.g., seconds) spent on each visited page. Apps accessed 310 indicates the applications on support website 108 accessed by the customer during the customer web session. Overall time spent 314 indicates a duration (e.g., seconds) spent on support website 108 from the start of the visit (i.e., start of the customer web session) until a prediction by WPI module 116.

With continued reference to data structure 300, customer intent 316 indicates an intent of the customer for each page and application on support website 108. For example, if the customer visited a particular page during the customer web session, customer intent 316 for that particular page can be set to a value of one (“1”). Otherwise, if the customer did not visit the particular page during the customer web session, customer intent 316 for that particular page can be set to a value of zero (“0”). Similarly, if the customer accessed a particular application during the customer web session, customer intent 316 for that particular application can be set to a value of one (“1”). Otherwise, if the customer did not access the particular application during the customer web session, customer intent 316 for that particular application can be set to a value of zero (“0”). Thus, customer intent 316 may be indicative of the customer’s interest with regards to the various pages and applications on support website 108 during the customer web session. Country of visited website 318 indicates the country of support website 108 visited by the customer (i.e., indicates the country in which the visited support website 108 is located). Number of clicks on each app 318 indicates the number of clicks made on each application on support website 108 during the customer web session. In some embodiments, the organization may specify applications on support website 108 that are of interest to the organization for this feature. This may be the case in instances where a support website includes a very large number of applications, where some of the applications may not be relevant in determining a propensity of a customer performing a particular action that is of interest to the organization (e.g., a propensity to contact the organization’s technical support or a propensity to make a purchase). In such cases, number of clicks on each app 318 indicates the number of clicks made on each specified application on support website 108 during the customer web session. Customer region 322 indicates the geographical region to which the customer belongs (e.g., a geographical region in which the organization is doing business and to which the customer of the customer web session belongs). Product info 324 indicates information regarding the product, such as, for example, type of product, current warranty status, product age, and product configuration. Content downloaded 326 indicates content (e.g., computer programs, articles, etc.) downloaded from support website 108 by the customer during the customer web session. Propensity to contact 330 indicates whether the customer contacted (e.g., “1 = Contact”), or did not contact (e.g., “0 = No Contact”), the organization’s technical support during the customer web session.

In data structure 300, each row may represent a training/testing sample (i.e., an instance of a training/testing sample) in the modeling dataset, and each column may show a different relevant feature of the training/testing sample. In some embodiments, the individual training/testing samples may be used to generate a feature vector, which is a multi-dimensional vector of elements or components that represent the features in a training/testing sample. In such embodiments, the generated feature vectors may be used for training/testing a ML classification model (e.g., a classification algorithm of contact propensity prediction engine 120) to predict a propensity of the customer contacting the organization’s technical support. The features web session ID 302, product ID 304, pages visited 306, time spent on each visited page 308, apps accessed 310, time spent on each accessed app 312, overall time spent 314, customer intent 316, country of visited website 318, number of clicks on each app 320, customer region 322, product info 324, and content downloaded 326 may be included in a training/testing sample as the independent variables, and the feature propensity to contact 330 included as the target variable (or “dependent variable”) in the training/testing sample.

Referring now to FIG. 3B and with continued reference to FIGS. 1A and 1B, shown is a diagram illustrating a portion of a data structure 350 that can be used to store information about relevant features of a modeling dataset for training a machine learning (ML) classification model to predict a propensity of a customer making a purchase, in accordance with an embodiment of the present disclosure. In FIG. 3B, like elements of FIG. 3A are shown using like reference designators and, unless context dictates otherwise, may not be described again for purposes of clarity. Data structure 350 may be in a tabular format in which the structured columns represent the different relevant features (variables) regarding the historical web journey data of the organization’s customers on support website 108 and a row represents individual historical web sessions of customers on support website 108. The relevant features illustrated in data structure 350 are merely examples of features that may be extracted from the historical web journey data of the organization’s customers on support website 108 and used to generate a modeling dataset and should not be construed to limit the embodiments described herein.

As shown in FIG. 3B, the relevant features may include web session ID 302, product ID 304, pages visited 306, time spent on each visited page 308, apps accessed 310, time spent on each accessed app 312, overall time spent 314, customer intent 316, country of visited website 318, number of clicks on each app 320, customer region 322, product info 324, content downloaded 326, and a propensity to purchase 360. Propensity to purchase 360 indicates whether the customer made a purchase (e.g., “1 = Purchase”), or did not make a purchase (e.g., “0 = No Purchase”), during the customer web session.

In data structure 350, each row may represent a training/testing sample (i.e., an instance of a training/testing sample) in the modeling dataset, and each column may show a different relevant feature of the training/testing sample. In some embodiments, the individual training/testing samples may be used to generate a feature vector, which is a multi-dimensional vector of elements or components that represent the features in a training/testing sample. In such embodiments, the generated feature vectors may be used for training/testing a ML classification model (e.g., a classification algorithm of purchase propensity prediction engine 122) to predict a propensity of the customer making a purchase. The features web session ID 302, product ID 304, pages visited 306, time spent on each visited page 308, apps accessed 310, time spent on each accessed app 312, overall time spent 314, customer intent 316, country of visited website 318, number of clicks on each app 320, customer region 322, product info 324, and content downloaded 326 may be included in a training/testing sample as the independent variables, and the feature propensity to purchase 360 included as the target variable (or “dependent variable”) in the training/testing sample.

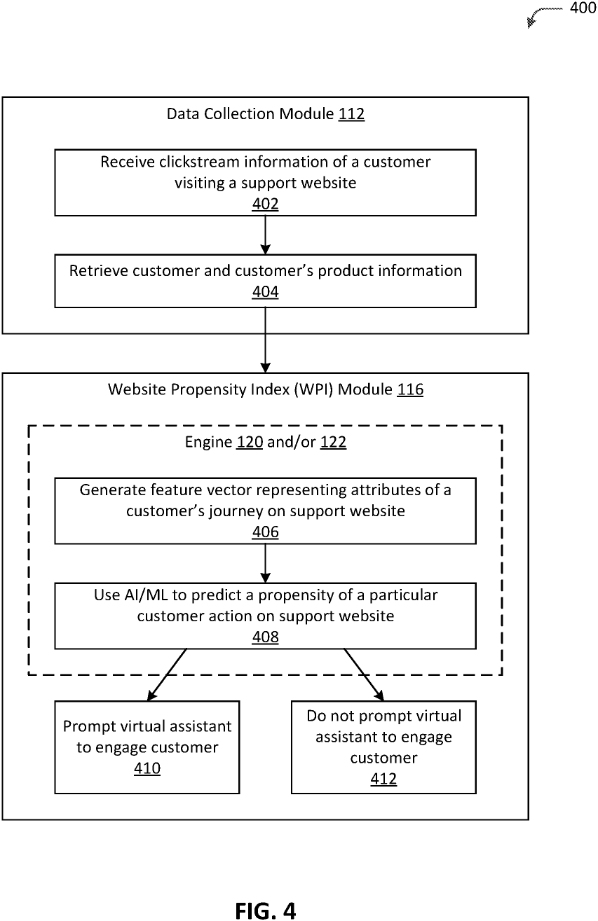

FIG. 4 is a flow diagram of an example process 400 for providing proactive support to customers visiting a support website, in accordance with an embodiment of the present disclosure. Process 400 may be implemented or performed by any suitable hardware, or combination of hardware and software, including without limitation the components of network environment 100 shown and described with respect to FIGS. 1A and 1B, the computing device shown and described with respect to FIG. 5, or a combination thereof. For example, in some embodiments, the operations, functions, or actions illustrated in process 400 may be performed, for example, in whole or in part by data collection module 112, WPI module 116, including engines 120 and 122, and virtual assistant interface module 118, or any combination of these including other components of proactive customer support service 110 described with respect to FIGS. 1A and 1B.

With reference to process 400 of FIG. 4 and with continued reference to FIGS. 1A and 1B, in an illustrative use case, at 402, data collection module 112 can receive clickstream information of a customer visiting support website 108. For example, the clickstream information of the customer may be received from hosting system 104. The clickstream information is indicative of an active or current web session of the customer on support website 108. The clickstream information of the customer may be continuously or periodically received during the duration of the customer’s active or current web session on support website 108. The clickstream information of the customer may be received on a continuous or periodic basis during the duration of the customer’s active or current web session on support website 108, as previously described herein. As a result, the clickstream information of the customer is real-time or near real-time data that is continually refreshed/updated during the customer’s active or current web session.

In response to the clickstream information of the customer being received, at 404, data collection module 112 can retrieve information about the customer and the customer’s product. For example, data collection module 112 can determine or otherwise identify a unique identifier of a product from the received clickstream information (e.g., determine the customer’s product from the information in the clickstream). Data collection module 112 can then use this information to retrieve information about the customer and the customer’s product from various enterprise systems and data repositories utilized by the organization. Data collection module 112 can then send or otherwise provide the clickstream information and the information about the customer and the customer’s product (i.e., the customer’s web journey data on support website 108) to WPI module 116 along with a request to provide proactive support to the customer.

In response to the request to provide proactive support to the customer being received, WPI module 116 can provide proactive customer support to the customer visiting support website 108. For example, WPI module 116 can use either or both contact propensity prediction engine 120 and/or purchase propensity prediction engine 122 to predict a propensity of the customer performing a particular action on support website 108 during the customer’s active or current web session on support website 108. For example, WPI module 116 can utilize contact propensity prediction engine 120 to predict a propensity of the customer contacting the organization’s technical support. WPI module 116 can utilize purchase propensity prediction engine 122 to predict a propensity of the customer making a purchase. In any case, WPI module 116 can provide proactive customer support to the customer based on the prediction.

In more detail, at 406, engine 120 and/or 122 can generate a feature vector that represents attributes of the customer’s web journey on support website 108. For example, engine 120 and/or 122 can generate the feature vector using the information included in the customer’s web journey data. The generated feature vector may include or represent some or all the variables (the features) that may influence the prediction by a ML classification model (e.g., a prediction of a propensity of the customer to contact the organization’s technical support by the ML classification model of engine 120 or a prediction of a propensity of the customer to make a purchase by the ML classification model of engine 122).

At 408, engine 120 and/or 122 can use AI/ML to predict a propensity of the customer performing a particular action on support website 108 during the customer’s active or current web session on support website 108. As explained above, in the illustrative use case of FIG. 4, the particular action is the customer contacting the organization’s technical support and/or the customer making a purchase during the customer’s active or current web session on support website 108. To make the prediction, engine 120 can input the feature vector representing attributes of the customer’s web journey on support website 108 to a ML classification model trained to predict a propensity of a customer contacting the organization’s technical support during the customer’s active or current web session on support website 108. Similarly, engine 122 can input the feature vector representing attributes of the customer’s web journey on support website 108 to a ML classification model trained to predict a propensity of a customer making a purchase during the customer’s active or current web session on support website 108.

WPI module 116 can then provide proactive customer support to the customer based on the prediction of the propensity of the customer performing the particular action. If the prediction is that the customer has a propensity of performing the particular action, at 412, WPI module 116 can prompt a VA component of support website 108 to engage the customer to assist the customer in performing the particular action. For example, if engine 120 predicts a propensity of the customer contacting the organization’s technical support, WPI module 116 can prompt the VA component to engage the customer to provide technical support (e.g., proactively assist the customer resolve their issue(s) with their product). Similarly, if engine 122 predicts a propensity of the customer making a purchase, WPI module 116 can prompt the VA component to engage the customer to proactively facilitate the purchase.

Otherwise, if the prediction is that the customer does not have a propensity of performing the particular action, at 414, WPI module 116 does not prompt the VA component of support website 108. In this case, the VA component may not engage the customer regarding performance of the particular action during the customer’s active or current web session on support website 108.

FIG. 5 is a block diagram illustrating selective components of an example computing device 500 in which various aspects of the disclosure may be implemented, in accordance with an embodiment of the present disclosure. As shown, computing device 500 includes one or more processors 502, a volatile memory 504 (e.g., random access memory (RAM)), a non-volatile memory 506, a user interface (UI) 508, one or more communications interfaces 510, and a communications bus 512.

Non-volatile memory 506 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 508 may include a graphical user interface (GUI) 514 (e.g., a touchscreen, a display, etc.) and one or more input/output (I/O) devices 516 (e.g., a mouse, a keyboard, a microphone, one or more speakers, one or more cameras, one or more biometric scanners, one or more environmental sensors, and one or more accelerometers, etc.).

Non-volatile memory 506 stores an operating system 518, one or more applications 520, and data 522 such that, for example, computer instructions of operating system 518 and/or applications 520 are executed by processor(s) 502 out of volatile memory 504. In one example, computer instructions of operating system 518 and/or applications 520 are executed by processor(s) 502 out of volatile memory 504 to perform all or part of the processes described herein (e.g., processes illustrated and described in reference to FIGS. 1A through 4). In some embodiments, volatile memory 504 may include one or more types of RAM and/or a cache memory that may offer a faster response time than a main memory. Data may be entered using an input device of GUI 514 or received from I/O device(s) 516. Various elements of computing device 500 may communicate via communications bus 512.

The illustrated computing device 500 is shown merely as an illustrative client device or server and may be implemented by any computing or processing environment with any type of machine or set of machines that may have suitable hardware and/or software capable of operating as described herein.

Processor(s) 502 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 502 may be analog, digital or mixed signal. In some embodiments, processor 502 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 510 may include one or more interfaces to enable computing device 600 to access a computer network such as a Local Area Network (LAN), a Wide Area Network (WAN), a Personal Area Network (PAN), or the Internet through a variety of wired and/or wireless connections, including cellular connections.

In described embodiments, computing device 500 may execute an application on behalf of a user of a client device. For example, computing device 500 may execute one or more virtual machines managed by a hypervisor. Each virtual machine may provide an execution session within which applications execute on behalf of a user or a client device, such as a hosted desktop session. Computing device 500 may also execute a terminal services session to provide a hosted desktop environment. Computing device 500 may provide access to a remote computing environment including one or more applications, one or more desktop applications, and one or more desktop sessions in which one or more applications may execute.

In the foregoing detailed description, various features of embodiments are grouped together for the purpose of streamlining the disclosure. This method of disclosure is not to be interpreted as reflecting an intention that the claims require more features than are expressly recited. Rather, inventive aspects may lie in less than all features of each disclosed embodiment.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

Elements of different embodiments described herein may be combined to form other embodiments not specifically set forth above. Other embodiments not specifically described herein are also within the scope of the following claims.

Reference herein to “one embodiment” or “an embodiment” means that a particular feature, structure, or characteristic described in connection with the embodiment can be included in at least one embodiment of the claimed subject matter. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the words “exemplary” and “illustrative” are used herein to mean serving as an example, instance, or illustration. Any aspect or design described herein as “exemplary” or “illustrative” is not necessarily to be construed as preferred or advantageous over other aspects or designs. Rather, use of the words “exemplary” and “illustrative” is intended to present concepts in a concrete fashion.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

All examples and conditional language recited in the present disclosure are intended for pedagogical examples to aid the reader in understanding the present disclosure, and are to be construed as being without limitation to such specifically recited examples and conditions. Although illustrative embodiments of the present disclosure have been described in detail, various changes, substitutions, and alterations could be made hereto without departing from the scope of the present disclosure. Accordingly, it is intended that the scope of the present disclosure be limited not by this detailed description, but rather by the claims appended hereto.

What is claimed is:

1. A method comprising:
receiving, by a computing device, clickstream information of a customer visiting a website of an organization, the clickstream information is indicative of an active web session of the customer on the website;
predicting, by the computing device using a machine learning (ML) model, a propensity of the customer performing a particular action during the active web session on the website; and
providing, by the computing device, proactive customer support to the customer based on the predicted propensity of the customer performing the particular action.

2. The method of claim 1, wherein the ML model is a ML classification model.

3. The method of claim 2, wherein the ML classification model is a gradient boosting classifier.

4. The method of claim 2, wherein the ML classification model is a random forest classifier.

5. The method of claim 2, wherein the ML classification model is a decision tree classifier.

6. The method of claim 2, wherein the ML classification model is a logistic regression model.

7. The method of claim 1, wherein the ML model is trained using a modeling dataset generated from a corpus of historical web journey data of customer web sessions on the website.

8. The method of claim 1, wherein the website is a support website of the organization.

9. The method of claim 1, wherein the particular action includes contacting technical support of the organization.

10. The method of claim 1, wherein the particular action includes making a purchase.

11. The method of claim 1, wherein providing proactive customer support includes prompting a virtual assistant (VA) of the website to engage the customer to proactively facilitate performance of the particular action.

12. A system comprising:
one or more non-transitory machine-readable mediums configured to store instructions; and
one or more processors configured to execute the instructions stored on the one or more non-transitory machine-readable mediums, wherein execution of the instructions causes the one or more processors to carry out a process comprising:
receiving clickstream information of a customer visiting a website of an organization, the clickstream information is indicative of an active web session of the customer on the website;
predicting, using a machine learning (ML) model, a propensity of the customer performing a particular action during the active web session on the website; and
providing proactive customer support to the customer based on the predicted propensity of the customer performing the particular action.

13. The system of claim 12, wherein the ML model is a ML classification model.

14. The system of claim 13, wherein the ML classification model is one of a gradient boosting classifier, a random forest classifier, a decision tree classifier, or a logistic regression model.

15. The system of claim 12, wherein the ML model is trained using a modeling dataset generated from a corpus of historical web journey data of customer web sessions on the website.

16. The system of claim 12, wherein the website is a support website of the organization.

17. The system of claim 12, wherein the particular action includes one of contacting technical support of the organization or making a purchase.

18. A method comprising:
receiving, by a computing device, clickstream information of a customer visiting a support website of an organization, the clickstream information is indicative of an active web session of the customer on the support website;
predicting, by the computing device using a machine learning (ML) classification model, a propensity of the customer performing a particular action during the active web session on the website; and
responsive to a prediction of the customer having a propensity to perform the particular action, prompting, by the computing device, a virtual assistant (VA) of the support website to engage the customer to proactively facilitate performance of the particular action.

19. The method of claim 18, wherein the ML classification model is one of a gradient boosting classifier, a random forest classier, a decision tree classifier, or a logistic regression model.

20. The method of claim 18, wherein the particular action includes one of contacting technical support of the organization or making a purchase.
